(19) United States
(12) Patent Application Publication
(10) Pub. No.: US 2003/0006660 A1
(43) Pub. Date: Jan. 9, 2003

(54) Electric Motor

(76) Inventors: Wolfgang Kehrer, Freiburg (DE); Wolfgang Frank, Buehl (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/009,531

(22) PCT Filed: Apr. 11, 2001
(86) PCT No.: PCT/DE01/01421

(30) Foreign Application Priority Data
Apr. 12, 2000 (DE) 1 00 18 156.2

(51) Int. Cl. H02K 5/16

(52) U.S. Cl. 310/90

(57) ABSTRACT

In an electric motor with a stator (11) and a rotor (12) that is received rotatably via its rotor shaft (13) in rotor bearings (14, 15), and having an effective decoupling between the stator (11) and rotor bearings (14, 15) for reducing the emission of airborne and structure-borne sound, in order to attain a structurally simple, sturdy design with markedly little motor noise, the rotor bearings (14, 15) are fixed on a housing (10) surrounding and gripping the stator (11), while the decoupling is achieved by a spring-elastic suspension of the stator (11) from the housing (10), and to that end elastic decoupling elements (28) are disposed between the stator (11) and the housing (10) (FIG. 1).

### PRIOR ART

The invention is based on an electric motor, especially for driving a blower in air conditioners, is generically defined by the preamble to claim 1.

In such electric motors, 12th- and 24th-order slot-frequency noises occur, which if the electric motor is for instance used as a blower motor in an air conditioner are emitted as airborne and structure-borne sound past the blower housing and cause quite irritating noises in the passenger compartment. Measures are therefore taken to reduce these noises extensively.

In one known low-noise electric motor of this type (U.S. Pat. No. 5,612,583), the stator is braced on the bearing sleeves of the rotor bearings via spring-elastic elements, which are each embodied as two concentric rings joined to one another in articulated fashion. The inner ring is secured to the bearing sleeve, and the outer ring is secured to the stator. The bearing sleeves are secured in turn in an external device, such as to the housing of a vacuum cleaner.

In another known low-noise electric motor (European Patent Disclosure EP 0 855 782), the rotor bearings are each received in a respective bearing hoop, and the bearing hoops are secured to the stator via noise-damping elements. The bearing hoops are embodied in caplike fashion and together with the cylindrical pole tube of the stator, which carries permanent magnet poles, they form a closed housing, which is inserted as a complete structural unit into the assembly to be driven.

### ADVANTAGES OF THE INVENTION

The electric motor of the invention has the advantage that noise reduction occurs along with a structural simple, sturdy design of the motor. Bearing hoops for the rotor bearings, which are complicated to produce and difficult to install, are dispensed with. The rotor bearings are instead secured rigidly to the housing by their bearing sleeves and can easily be jointly injection-molded in the process of producing the housing by injection molding. The rotor bearings, preferably embodied as slide bearings, cannot transmit tangential forces of the rotor, and they are thus decoupled from the stator. Because of the spring-elastic fastening of the stator to the housing, there is no rigid connection between the stator and the housing, which prevents the transmission of structure-borne sound from the stator to the housing.

By the provisions recited in the further claims, advantageous refinements and improvements to the electric motor defined by claim 1 are possible.

In one advantageous embodiment of the invention, for the spring-elastic suspension of the stator from the housing, decoupling elements, at which the stator is retained by nonpositive and/or positive engagement are secured to the inner wall of a housing pot, spaced apart from one another in the circumferential direction.

In a preferred embodiment of the invention, the decoupling elements comprise an elastomer and, by the two-component process, are jointly injection-molded onto the plastic injection-molded housing.

### DRAWING

The invention is explained in further detail in the ensuing description, in terms of exemplary embodiments shown in the drawing. The drawings, each schematically, show the following:

FIG. 1, a longitudinal section through an electric motor;

FIG. 2, a side view of an electric motor, somewhat modified from FIG. 1, without a housing;

FIG. 3, a detail of a section taken along the line III-III in FIG. 2;

FIG. 4, a detail showing a plan view in the direction of the arrow IV in FIG. 2.

### DESCRIPTION OF THE EXEMPLARY EMBODIMENT

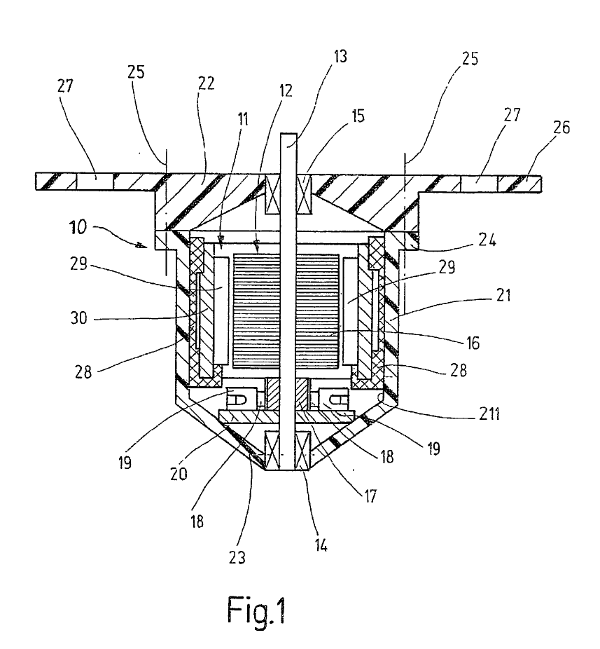

The electric motor, schematically shown in longitudinal section in FIG. 1 and preferably used in motor vehicles, in particular as a blower motor in air conditioners, is embodied here as a commutator motor as an example and in a known manner has a stator 11 and a rotor 12 that rotates in the stator 11; to that end, with its rotor body 16 which for instance is laminated and is also known as a rotor lamination packet, the rotor is seated in a manner fixed against relative rotation on a rotor shaft 13, which is received in rotor bearings 14, 15 embodied here as slide bearings. A rotor winding, not shown for the sake of simplicity, rests in axial slots of the rotor body 16 and is electrically connected to a current inverter or commutator 17 that is seated on the rotor shaft 13 in a manner fixed against relative rotation. For delivering current to the rotor winding, commutator or carbon brushes 18 are used, which are guided radially displaceably in so-called quivers 19 of a brush holder 20 and are pressed against the commutator 17 with spring prestressing.

The stator 11 and rotor 12 are received in a housing 10 with a housing pot 21 that is closed by a housing cap 22. To that end, on the end of the pot remote from the bottom 23 of the housing pot 21, a radial flange 24 receiving the housing cap 22 is formed; the housing cap 22 is screwed to this radial flange, for instance by means of screw connections 25, which are indicated by dot-dashed lines in FIG. 1. The housing cap 22 in turn carries a fastening flange 26, embodied integrally with the housing cap 22. The fastening flange 26 is provided with fastening holes 27, through which fastening screws, for instance, can be inserted in order to secure the electric motor in some assembly, such as the blower housing of an air conditioner.

The rotor bearings 14, 15 for receiving the rotor shaft 13 are fixed to the housing; the rotor bearing 14 is integrated with the bottom 23 of the housing pot 21, and the rotor bearing 15 is integrated with the housing cap 22. The housing pot 21 and housing cap 22 are for instance of plastic and for instance are injection-molded, and the rotor bearings 14, 15 are for instance jointly injection-molded simultaneously in the injection molding process. For decoupling structure-borne sound emission from the stator 11 to the housing 10, the stator 11 is suspended from the housing pot 21 spring-elastically. To that end, decoupling elements 23 spaced apart from one another in the circumferential direction are secured to the inner wall 211 of the housing pot 21, and the stator 11 is retained by nonpositive and/or positive engagement on these elements. The stator 11, which comprises a pole tube 30 equipped with permanent magnet poles 29, is braced with its pole tube 30 indirectly, for instance, on the decoupling elements 28. In the exemplary embodiment of FIG. 1, four decoupling elements 28 are provided, offset from one another by 90° of an angle of rotation each, so that in the sectional view, two of these decoupling elements 28 can be seen. The decoupling elements 28 extend for instance over the entire axial length of the pole tube 30 and protrude somewhat from the face end.

In the modified exemplary embodiment of FIGS. 2-4, there are a total of three decoupling elements 28, offset by an angle of rotation of 120° from one another and again extending over the full length of the pole tube 30. The decoupling elements 28 for instance comprise an elastomer and are jointly injection-molded by the two-component process onto the housing pot 21 injection-molded from plastic. As the elastomer for the decoupling elements 28, the elastomer TO..623/60A made by TCT is for instance suitable.

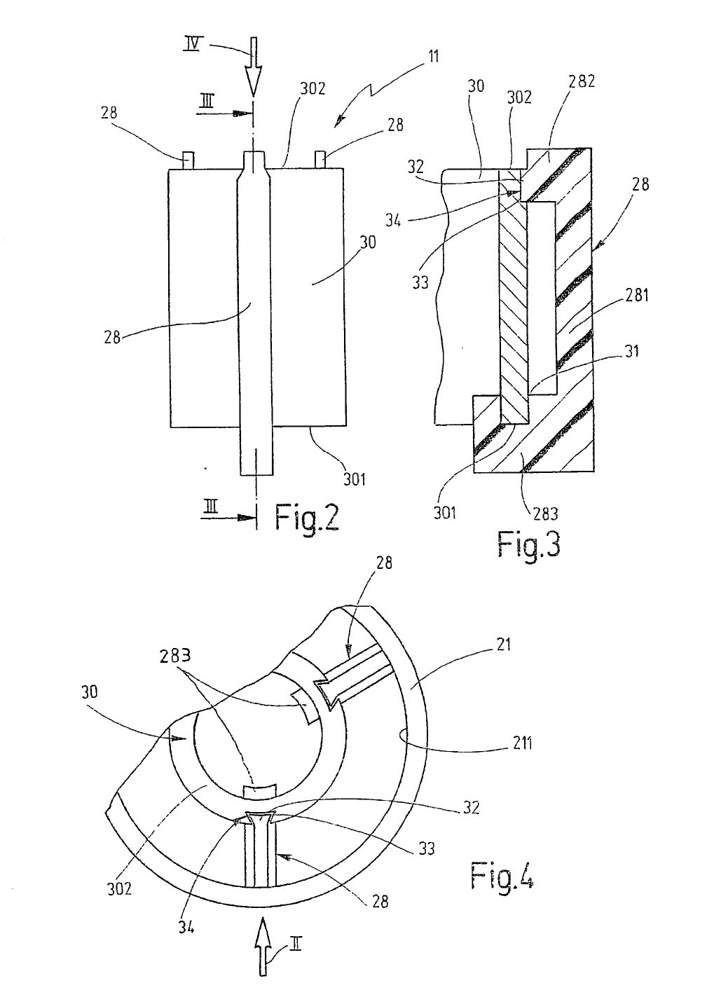

As best seen from the sectional view of FIG. 3, each decoupling element 28 has a C-shaped profile, with one longitudinal rib 281 that is injection-molded onto the inner wall 211 of the housing pot 21 (FIG. 4), with a short leg 282 protruding at right angles from the longitudinal rib 281 toward the rotor shaft 13, and with a long leg 283 protruding at right angles from the longitudinal rib 281 toward the rotor shaft. In the long leg 283, from the inside of the leg oriented toward the short leg 282, a curved or annular-segment slot 31 is made, which extends over the full width, in the circumferential direction, of the long leg 283. This slot 31 is embodied such that the pole tube 30 can be inserted by a portion of one face end 301 into the slot 31 by positive engagement. On the free end, toward the pole tube 30, of the short leg 282, a positive-engagement element is for instance embodied, which cooperates with a positive- engagement element embodied on the outer jacket of the pole tube 30, near the other face end 302 thereof. In the exemplary embodiment of FIGS. 2-4, the two positive-engagement elements are formed by the groove 33 and tongue 32 of a dovetail connection 34; the tongue 32—as seen in FIG. 4—is disposed on the short leg 282 of the decoupling element 28, and the groove 33 is disposed on the pole tube 30. The groove 33 of the dovetail connection 34, machined into the pole tube 30, is open toward the face end 302 of the pole tube 30, so that the tongue 32 can be pressed axially into the groove 33 on the elastic decoupling element 28.

Upon assembly of the electric motor, the structural group, completely preassembled with the stator 11, rotor 12, rotor shaft 13 and commutator 17, is inserted into the housing pot 21 from above; the brush holder 20 fixed to the housing pot 21 has already been installed before this. The commutator 17 must be thrust between the carbon brushes 18 of the brush holder 20 until the rotor shaft can be inserted at its end into the rotor bearing 14 in the cup bottom 23. At the end of this assembly process, the pole tube 30 with its face end 301 dips into the slots 31 in the lower, long leg 283 of the decoupling elements 28 and is clipped with its grooves 33 of the dovetail connections 34 onto the tongues 32 of the dovetail connections 34, these tongues being formed on the spring-elastic decoupling elements 28, so that the grooves 33 and tongues 32 snap into one another. In the exemplary embodiment of FIGS. 2-4, the pole tube is thus retained positively at three points offset from one another by 120° of rotation on the one hand in the lower long legs 283 and on the other by positive engagement on the upper short legs 282 of the three decoupling elements 28.

The invention is not limited to the exemplary embodiments described. For instance, the pole tube 30 need not be a closed hollow cylinder but can instead be put together from hollow-cylindrical wall segments that each extend in the circumferential direction over at least one pair of poles. Such pole tube segments are retained in the same way in the decoupling elements 28 as described above, but in that case at least two decoupling elements 28 per pole tube segment are required.

In a closed, hollow-cylindrical pole tube 30 as described above, it is also possible to dispense with a positive engagement between the pole tube 30 and the decoupling elements 28 by designing the decoupling elements 28 such that the pole tube 30 is clamped in the radial direction between the decoupling elements 28 and is thus held by nonpositive engagement between the decoupling elements 28. A nonpositive engagement makes a simpler embodiment of the decoupling elements 28 possible; then they need merely be injection-molded in the form of shell-like segments onto the inner wall 211 of the housing pot 21. If applicable, a means of securing against rotation should also be provided.

1. An electric motor, having a stator (11) and a rotor (12) that is rotatable in the stator (11) and that has a rotor shaft (13), received rotatably in rotor bearings (14, 15), and having an effective decoupling for reducing the emission of airborne and structure-borne sound between the stator (11) and the rotor bearings (14, 15), characterized in that the rotor bearings (14, 15) are fixed on a housing (10) that surrounds and grips the stator (11), and that the decoupling is achieved by means of a spring-elastic suspension of the stator (11) from the housing (10).

2. The electric motor of claim 1, characterized in that for the spring-elastic suspension of the stator (11) from the housing (10), decoupling elements (28), at which the stator (11) is retained by nonpositive and/or positive engagement are secured to the inner wall (211) of a housing pot (21), spaced apart from one another in the circumferential direction.

3. The electric motor of claim 2, characterized in that at least three decoupling elements (48), offset from one another by the same angle of rotation, are provided, each extending over the entire axial length of the stator (11).

4. The electric motor of claim 2 or 3, characterized in that the decoupling elements (28) comprise an elastomer and, preferably by the two-component process, are jointly injection-molded onto the plastic injection-molded housing (21).

5. The electric motor of one of claims 2-4, characterized in that the decoupling elements (28) have a C-shaped profile and protrude radially to the rotor shaft (13) away from the housing pot (21) with both legs (282, 283) of the C, which are joined together by a longitudinal rib (281), and that means for coupling the stator (11) by positive engagement are held up in each of the legs (282, 283) of the C.

6. The electric motor of claim 5, characterized in that the stator (11) has a pole tube (30) equipped with permanent magnet poles (29), and that on one leg (283) of the C of the decoupling elements (28), an annular-segment slot (31) is provided for positive-engagement insertion of one face end (301) of the pole tube (30), and on the other leg (282) of the C of the decoupling elements (28), a positive- engagement element cooperating with a positive-engagement element embodied on or in the jacket of the pole tube (30) is provided.

7. The electric motor of claim 6, characterized in that the two positive-engagement elements form a tongue (32) and groove (33) of a dovetail connection (34).

8. The electric motor of claim 7, characterized in that the groove (33) of the dovetail connection (34) is machined into the jacket of the pole tube (30), and the tongue (32) of the dovetail connection (34) protrudes from the free end face, oriented toward the pole tube (30), of the leg (282) of the C of the decoupling elements (28).

9. The electric motor of one of claims 2-8, characterized in that the housing pot (21) is closable with a housing cap (22) that carries a fastening flange (26), and that the rotor bearings (14, 15) are disposed in the pot bottom (23) of the housing pot (21) and in the housing cap (22), respectively.
